(19) United States
(12) Patent Application Publication
(10) Pub. No.: US 2012/0325061 A1
(43) Pub. Date: Dec. 27, 2012

(54) MACHINING DEVICE

(75) Inventors: Qian-Long LIAO, Shenzhen City (CN); Cong-Cong WANG, Shenzhen City (CN); Jing-Hui YOU, Shenzhen City (CN)

(73) Assignees: HON HAI PRECISION INDUSTRY CO., LTD., Tu-Cheng (TW); Fu Tai Hua Industry (Shenzhen) Co., Ltd., ShenZhen City (CN)

(21) Appl. No.: 13/302,096

(22) Filed: Nov. 22, 2011

(30) Foreign Application Priority Data
Jun. 24, 2011 (CN) 201110173017.3

(51) Int. Cl. B23Q 5/52; B23P 13/00; B23B 13/02

(52) U.S. Cl. 82/19

(57) ABSTRACT

A machining device includes a support platform, a machining assembly, a clamping assembly, a driving assembly, and a controlling assembly. The support platform includes a first supporting member, a sliding rail mounted on the first supporting member, and a second supporting member mounted on the sliding rail. The machining assembly mounted on the second supporting member includes a machining tool. The clamping assembly is mounted on the first supporting member, for clamping and rotating the workpiece. The driving assembly is fixed to the second supporting member. The controlling assembly includes a connecting member mounted on the second supporting member and a resisting member mounted on the connecting member. The driving member drives the second supporting member to slide along the sliding rail, to make a gradual and increasing depth of contact by the machining tool on the workpiece, until a preset limit is reached.

### BACKGROUND

1. Technical Field

The present disclosure relates to machining devices, particularly to a machining device for machining a side surface of a workpiece.

2. Description of Related Art

The machining of an irregular surface of a workpiece, or the fabrication of an irregular shape, often makes use of a computer numerical control machine. But in the processing of the workpiece, the workpiece may need to be rotated or turned over for the machining of another surface of the workpiece. Thus the computer numerical control machine needs a complex control program to accomplish the automatic rotating of the workpiece. In addition, the workpiece needs to be positioned again after having being turned over, so that a positional deviation may occur, and this affects the accuracy of the machining processing.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of an embodiment of a machining device.

FIG. 2 is similar to FIG. 1, but viewed from another aspect.

FIG. 3 is an enlarged, sectional view of the enlarged sectional view III shown in FIG. 2 to illustrate the machining operation.

### DETAILED DESCRIPTION

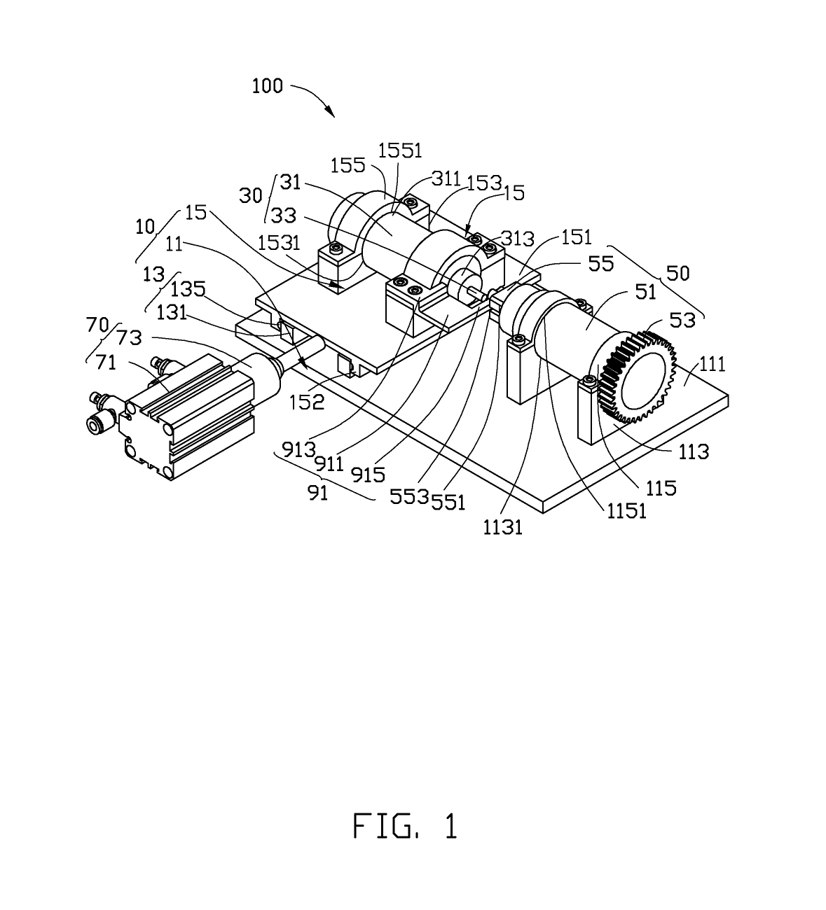

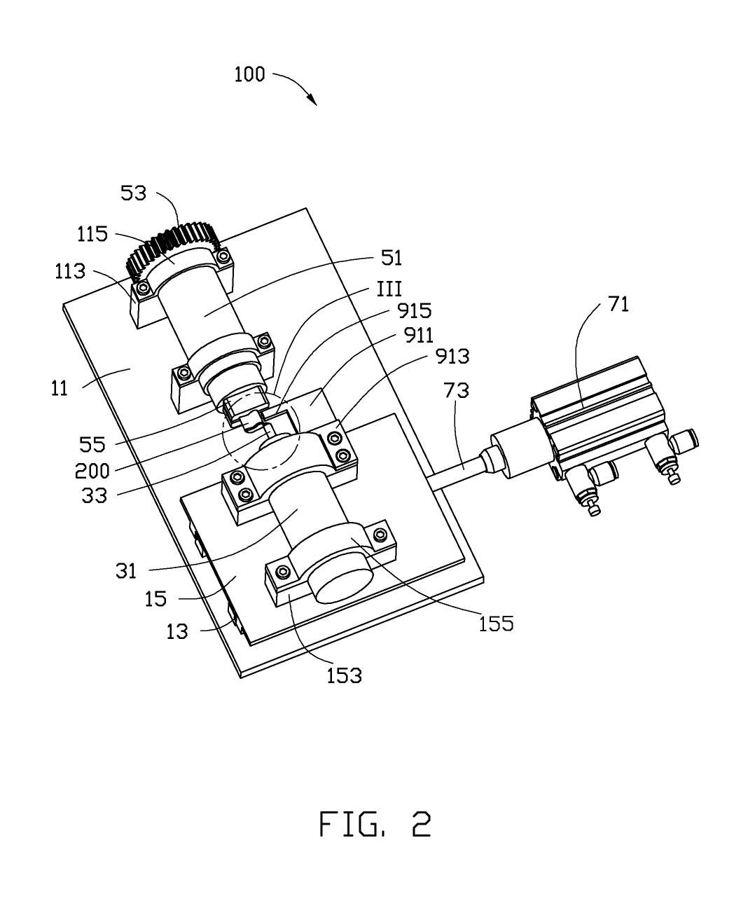

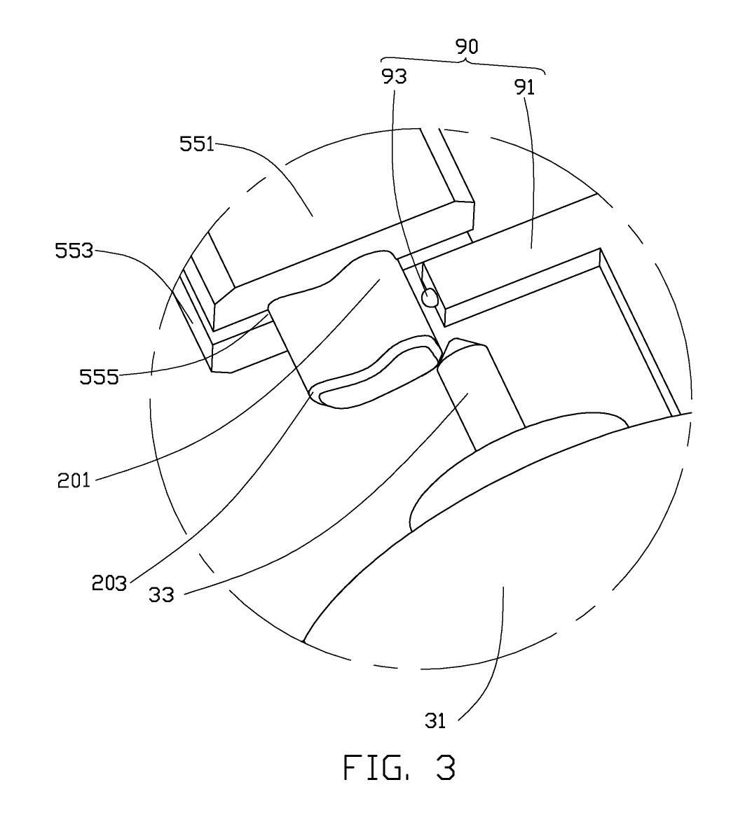

Referring to FIGS. 1 to 3, an embodiment of a machining device 100 for processing a side surface 201 of a workpiece 200, includes a support platform 10, a machining assembly 30, a clamping assembly 50, a driving assembly 70 and a controlling assembly 90. The machining assembly 30, the clamping assembly 50 and the controlling assembly 90 are located on the support platform 10. The machining assembly 30 is used for machining a surface of the workpiece 200. The clamping assembly 50 is used for clamping the workpiece 200. The driving assembly 70 is connected to the support platform 10 to drive the machining assembly 30 and to move the controlling assembly 90. The controlling assembly 90, acting as governor for the machining assembly 30, is constantly in contact with the workpiece 200, and is capable of precisely following the contours of the workpiece 200. In the illustrated embodiment, referring to FIG. 3, the machining surface of the workpiece 200 is a surface 203, and the surface 203 is an irregular surface surrounding the side surface 201 of the workpiece 200. The machining device 100 is used to shape the workpiece 200, and in this embodiment, the machining device 100 is used to form a chamfer on the surface 203 of the workpiece 200.

The support platform 10 includes a first supporting member 11, a pair of sliding rails 13, and a second supporting member 15. The pair of sliding rails 13 is positioned on the first supporting member 11 adjacent to one end of the first supporting member 11, and the second supporting member 15 is slidably located on the sliding rails 13. The first supporting member 11 includes a base plate 111, a pair of first extending portions 113 and a pair of first fixing portions 115 attached to the first extending portions 113. The base plate 111 is substantially flat. Each sliding rail 13 includes a guiding rail 131, and a plurality of rolling balls (not shown). The guiding rails 131 are a plurality of substantial bars, and protrude out from the base plate 111.

Each first extending portion 113 is a block, and substantially perpendicularly protrudes out from the base plate 111 adjacent to the pair of sliding rails 13. The two first extending portions 113 are parallel to each other. Each first extending portion 113 defines a first depression 1131 in the distal end thereof away from the base plate 111. In the illustrated embodiment, the first depression 1131 is substantially semicircular to contain and support the clamping assembly 50. Each first fixing portion 115 is substantially a flanged semicircular structure defining a second depression 1151. The second depression 1151 is substantially semicircular with a size corresponding to the first depression 1131. The two ends of each of the first fixing portions 115 are fixed to the two opposite edges of the distal end of each first extending portion 113, respectively, such that each first extending portion 113 and the corresponding first fixing portion 115 cooperatively together define a hole to allow the clamping assembly 50 to pass through. The number of the first extending portion 113 or the first fixing portion 115 can be one or more.

The second supporting member 15 includes a support plate 151, a pair of sliding portions 152, a pair of second extending portions 153 and a pair of second fixing portions 155 attached to the second extending portions 153. The support plate 151 is substantially flat, and the supporting plate 151 is smaller than the base plate 111. The sliding portions 152 are also substantially shaped in a plurality of bars on the surface of the second supporting member 15 facing the sliding rail 13. The sliding portions 152 are matched with the guiding rails 131. The sliding portions 152 are located precisely on the guiding rail 131, and define a channel 135. Rolling balls (not shown) are placed in the channel 135 along the span of the channel 135, thus the sliding portions 152 can slide along the guiding rail 131, and the second supporting member 15 can move along with the sliding portions 152. Other sliding mechanisms such as rollers may be substituted for the sliding rail 13.

Each second extending portion 153 perpendicularly protrudes out from the surface of the support plate 151 away from the base plate 111, and the two second extending portions 153 are parallel to each other. The second extending portions 153 have the same shape as the first extending portions 113, and each second extending portions 153 defines a third depression 1531 in the distal end thereof away from the support plate 151. In the illustrated embodiment, the third depression 1531 is substantially semicircular to contain and support the machining assembly 30. Each second fixing portion 155 is substantially a flanged semicircular structure defining a fourth depression 1551. The fourth depression 1551 is substantially semicircular and has a size corresponds to the third depression 1531. The two ends of each of the second fixing portions 155 are fixed to the two opposite edges of the distal end of each second extending portion 153, respectively, such that each second extending portion 153 and the corresponding second fixing portion 155 cooperatively define a hole to allow a spindle 31 to pass through. The number of the second extending portions 153 or the second fixing portions 155 can be one or more.

The machining assembly 30 is used to machine the workpiece 200, and includes a spindle 31, a machining tool 33, and a driving member (not shown) connected to the spindle 31. The spindle 31 can be rotated by the driving member, and the machining tool 33 is rotated by the spindle 31. The spindle 31 is substantially a cylinder, and includes a body 311 and a tool-post 313 extending from an end of the body 311. The body 311 is received in the hole defined by the second extending portions 153 and the second fixing portions 155. The tool-post 313 extends towards the extending portions 113, and axially defines a mounting hole (not shown) for mounting the machining tool 33. The machining tool 33 is mounted in the mounting hole, and extends out from the tool-post 313 towards the clamping assembly 50. In the illustrated embodiment, the machining tool 33 is a tungsten steel cutter. The driving member is a motor.

The clamping assembly 50 is used to clamp the workpiece 200, and includes a main body 51, a gear member 53, a driving member (not shown), and a clamping member 55. The main body 51 is substantially a cylinder, and is received in the hole defined by the first extending portions 113 and the first fixing portions 115. The gear member 53 is mounted at the end of the main body 51 away from the spindle 31, and connected to the driving member. The gear member 53 can be rotated by the driving member, and the main body 51 is rotated by the gear member 53. The rotational direction of the spindle 31 is contrary to the rotational direction of the main body 51.

The clamping member 55 is mounted at the distal end of the main body 51 opposite to the gear member 53, and is rotated by the main body 51. The clamping member 55 includes a first clamping portion 551 and a second clamping portion 553. The first clamping portion 551 and the second clamping portion 553 extend from the distal end of the main body 51 towards the machining tool 33, and are apart and parallel to each other. The first clamping portion 551 and the second clamping portion 553 are both a block, and define a containing portion 555 for clamping a part of the workpiece 200. The rotational direction of the machining tool 33 can be the same as the rotational direction of the main body 51 but at different speeds.

The driving assembly 70 is used to drive the support plate 151 and the machining assembly 30 and the controlling assembly 90 mounted on the support plate 151. The driving assembly 70 is placed beside the support plate 151, and includes a driving member 71 and a driving rod 73 connected to the driving member 71. The driving rod 73 is fixed to the support plate 151 at the end thereof away from the driving member 71, and parallels to the guiding rails 131. The driving member 71 drives the driving rod 73 to move away from the driving member 71, and thereby drives the support plate 151 to move along the guiding rail 131 away from the driving member 71. The machining assembly 30 and the controlling assembly 90 mounted on the support plate 151 can also be made to move along with the support plate 151. In the illustrated embodiment, the driving member 71 is a cylinder mounted in a cuboid case.

The controlling assembly 90 includes a connecting member 91 and a resisting member 93 mounted on an end of the connecting member 91. The connecting member 91 interconnects the resisting member 93 with the second supporting member 15, and the resisting member 93 resists and follows the side surface 201 of the workpiece 200. The connecting member 91 includes a body 911, a fixing portion 913 and a protruding portion 915. The body 911 is a plate. The fixing portion 913 is formed at the distal end of the body 911, and is fixed on an end of the second fixing portion 155. The protruding portion 915 protrudes perpendicularly from the end of the body 911 opposite to the fixing portion 913 towards the space between the clamping member 55 and the machining tool 33. The outer end of the resisting member 93 is hemispherical, and the resisting member 93 is mounted at the distal end of the protruding portion 915 opposite to the body 911. In the illustrated embodiment, the resisting member 93 is made of tungsten.

In assembly, first, the support plate 151 is mounted on the sliding rail 13, and the guiding rails 131 and the sliding portions 152 are parallel to the first extending portions 113. The body 311 of the spindle 31 is placed in the third depression 1531, and held in place by the second extending portions 153. The second fixing portions 155 are fixed to the second extending portions 153, and enclose the body 311. The body 311 is received in the hole defined by the second extending portions 153 and the second fixing portion 155. A gap between the body 311 and the second fixing portions 155 exists to allow the rotation of the spindle 31. The tool-post 313 faces the extending portions 113. The machining tool 33 is mounted on the tool-post 313.

The main body 51 of the clamping assembly 50 is then received in the first depression 1131, and held in place by the first extending portions 113. The first fixing portions 115 are fixed to the first extending portions 113, and enclose the main body 51. The main body 51 is received in the hole defined by the first extending portions 113 and the first fixing portion 115. A gap between the main body 51 and the first fixing portions 115 exists to allow the rotation of the main body 51. The gear member 53 is mounted on the end of the main body 51 away from the machining assembly 30, and the driving member of the clamping assembly 50 is connected to the gear member 53. The clamping member 55 is mounted on the end of the body opposite to the gear member 53. The driving member 71 is then located beside the base plate 111, and the driving rod 73 is mounted on the driving member 71 and connected to the support plate 151 at the end thereof opposite to the driving member 71. Next, the fixing portion 913 of the controlling assembly 90 is fixed on the second fixing portion 155, and the protruding portion 915 points towards the space between the clamping member 55 and the machining tool 33.

In use, the workpiece 200 is inserted into the containing portion 555, and the machining tool 33 is placed against the side surface 201 of the workpiece 200. The resisting member 93 is located near the workpiece 200, and the distance between the side surface 201 and the resisting member 93 is made equal to the lateral depth of the required machining. The driving member of the machining assembly 30 and the driving member of the clamping assembly 50 are actuated to make the spindle 31 and the main body 51 rotate, thus the machining tool 33 and the workpiece 200 are rotated along with the rotation of the spindle 31 and the main body 51. The driving member 71 is then started to drive the driving rod 73 to move away from the driving member 71, and thus the support plate 151 is driven to move along the sliding rail 13. The machining tool 33 then machines the desired chamfer into the surface 203 of the workpiece 200.

Since the side surface 201 and the surface 203 which is to be chamfered are irregular surfaces, when a protruding portion of the workpiece 200 rotates to bind against the resisting member 93, the workpiece 200 may push the resisting member 93 to push the support plate 151 towards the driving member 71. The machining tool 33 thus also moves away from the workpiece 200 and maintains the depth of contact on the surface 203. During rotation, when the resisting member 93 meets a depression region of the workpiece 200, the support plate 151 is driven to move away from the driving member 71. The resisting member 93 and the machining tool 33 thus move a corresponding and precise distance towards the workpiece 200, and the required depth of contact with the workpiece 200 is maintained.

When the machining tool 33 machines the workpiece 200, the resisting member 93 keeps in contact with the side surface 201 under the pressure of the driving member 71, thus the machining tool 33 keeps on machining to the full extent of the preset machining depth. The machining of the workpiece 200 having irregular shape is achieved more easily, smoothly and precisely.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A machining device, used for processing a surface of a workpiece, comprising:
a support platform comprising a first supporting member, at least one sliding rail mounted on the first supporting member, and a second supporting member mounted on the sliding rail;
a machining assembly mounted on the second supporting member, the machining assembly comprising a machining tool to machine the workpiece;
a clamping assembly mounted on the first supporting member towards the machining assembly to clamp and rotate the workpiece;
a driving assembly connected to the second supporting member to drive the second supporting member; and
a controlling assembly comprising a connecting member fixed to the second supporting member, and a resisting member mounted on an end of the connecting member;
wherein the driving member is capability of driving the second supporting member to slide along the sliding rail to make the machining assembly and the controlling assembly to move along with the second supporting member, at the same time, the machining tool machines the workpiece and the resisting member maintains the depth of contact on the surface of workpiece.

2. The machining device of claim 1, wherein the connecting member comprises a body, a fixing portion formed at the distal end of the body, and a protruding portion protruded out from an end of the body opposite to the fixing portion; the fixing portion is fixed to the second supporting member; the resisting member is mounted at the distal end of the protruding portion opposite to the body to keep contacting on the surface of the workpiece.

3. The machining device of claim 1, wherein the clamping assembly comprises a main body, a clamping member, and a driving member connected to the main body; the clamping member is mounted on the distal end of the main body towards the machining tool to clamp the workpiece; the main body is rotatably driven by the driving member; and the clamping member is rotatably controlled by the main body.

4. The machining device of claim 3, wherein the first supporting member comprises a base plate, at least one first extending portion protrudes out from the support plate, and at least one first fixing portion attached to each of the first extending portion; the first extending portion defines a first depression, and the first fixing portion defines a second depression corresponding to the size of the first depression; the first extending portion and the first fixing portion define a hole cooperatively to allow the main body to pass through.

5. The machining device of claim 1, wherein the machining assembly further comprises a spindle mounted on the second supporting member, and a driving member connected to the spindle; the spindle is rotatably driven by the driving member; the machining tool is mounted on an end of the spindle, and is rotatably driven by the spindle.

6. The machining device of claim 5, wherein the second supporting member comprise a support plate, at least one second extending portion protrudes out from the support plate, and at least one second fixing portion attached to the second extending portion; the second extending portion defines a third depression, and the second fixing portion defines a fourth depression corresponding to the third depression; the second extending portion and the second fixing portion define a hole cooperatively to allow the spindle to pass through.

7. The machining device of claim 5, wherein the machining tool is a cutter.

8. The machining device of claim 1, wherein the driving assembly comprises a driving member and a driving rod connected to the driving member; the driving rod is fixed to the second supporting member; the driving member drives the driving rod to move away from the driving member, and thereby drive the second supporting member to move along the sliding rail.

9. A machining device, used for processing a surface of a workpiece, comprising:
a support platform comprising a first supporting member, and a second supporting member movably mounted on the first supporting member;
a machining assembly mounted on the second supporting member, the machining assembly comprising a machining tool used to process the workpiece;
a clamping assembly mounted on the first supporting member relative to the machining assembly to clamp and rotate the workpiece;
a driving assembly connected to the second supporting member to drive the second supporting member; and
a controlling assembly comprising a connecting member fixed to the second supporting member, and a resisting member mounted on an end of the connecting member;
wherein the resisting member is a partial sphere; the driving assembly drives the second supporting member to move relative to the first supporting member to make the machining assembly and the controlling assembly to move along with the second supporting member, at the same time, the machining tool machines the workpiece, and the resisting member maintains the depth of contact on the surface of the workpiece.

10. The machining device of claim 9, wherein the connecting member comprises a body, a fixing portion formed at the distal end of the body, and a protruding portion protruded out from an end of the body opposite to the fixing portion; the fixing portion is fixed to the second supporting member; the resisting member is mounted at the distal end of the protruding portion opposite to the body, to keep contacting on the surface of the workpiece.

11. The machining device of claim 9, wherein the clamping assembly comprises a main body, a clamping member, and a driving member connected to the main body; the clamping member is mounted on the distal end of the body towards the machining tool to clamp the workpiece; the main body is rotatably driven by the driving member; the clamping member is rotatably controlled by the main body.

12. The machining device of claim 11, wherein the first supporting member comprises a base plate, a first extending portion protrudes out from the support plate, and a first fixing portion attached to the first extending portion; the first extending portion defines a first depression, and the first fixing portion defines a second depression corresponding to the first depression; the first extending portion and the first fixing portion define a hole cooperatively to allow the main body to pass through.

13. The machining device of claim 9, wherein the machining assembly further comprises a spindle mounted on the second supporting member, and a driving member connected to the spindle; the spindle is rotated driven by the driving member; the machining tool is mounted on an end of the spindle, and is rotatably driven by the spindle.

14. The machining device of claim 13, wherein the second supporting member comprises a support plate, at least one second extending portion protrudes out from the support plate, and at least one second fixing portion attached to the second extending portion; the second extending portion defines a third depression, and the second fixing portion defines a fourth depression having a size corresponding to the third depression; the second extending portion and the second fixing portion define a hole cooperatively to allow the spindle to pass through.

15. The machining device of claim 14, wherein the machining tool is a cutter.

16. The machining device of claim 9, wherein the driving assembly comprises a driving member and a driving rod connected to the driving member; the driving rod is fixed to the second supporting member; the driving member drives the driving rod to move away from the driving member, and thereby drives the second supporting member moving relative to the first supporting member.

17. The machining device of claim 9, wherein the outer end of the resisting member is hemispherical, and the resisting member is made of tungsten.
